(19) United States
(12) Patent Application Publication
(10) Pub. No.: US 2006/0001398 A1
(43) Pub. Date: Jan. 5, 2006

(54) Fuel cell-based charger for computer system

(76) Inventor: Don J. Nguyen, Portland, OR (US)

Correspondence Address: BUCKLEY, MASCHOFF, TALWALKAR LLC, 5 ELM STREET, NEW CANAAN, CT, 06840, US

(21) Appl. No.: 10/881,458

(22) Filed: Jun. 30, 2004

(51) Int. Cl. H01M 10/44

(52) U.S. Cl. 320/101

(57) ABSTRACT

A system may include a fuel cell to generate power, and a voltage regulator coupled to the fuel cell, the voltage regulator to regulate the generated power, and to charge a battery of a mobile computing system with the regulated power.

### BACKGROUND

The usefulness of a mobile computing system often depends on how long the system can operate without being connected to a stationary power source, such as an AC outlet. Designers of mobile computing systems attempt to extend the length of this period by optimizing the power consumption of such systems. Since such mobile operation requires an attached, mobile power source, the period may also be lengthened by improving conventional or developing new mobile power sources.

Fuel cells have been proposed as one promising mobile power source. More particularly, a system consisting of one or more fuel cells, fuel, control elements and processing/delivery elements might provide mobile and renewable power to a mobile computing system. However, conventional mobile computing systems and fuel cell systems are not equipped for efficient interoperation.

### BRIEF DESCRIPTION OF THE DRAWINGS

FIG. 1 is a block diagram of a system according to some embodiments.

FIG. 2 is a block diagram of a fuel cell system according to some embodiments.

FIG. 3 is a block diagram of a system charger voltage regulator according to some embodiments.

FIG. 4 is diagram of a process according to some embodiments.

FIG. 5 is a block diagram of a system according to some embodiments.

FIG. 6 is a block diagram of a system charger voltage regulator according to some embodiments.

FIG. 7 is diagram of a process according to some embodiments.

### DETAILED DESCRIPTION

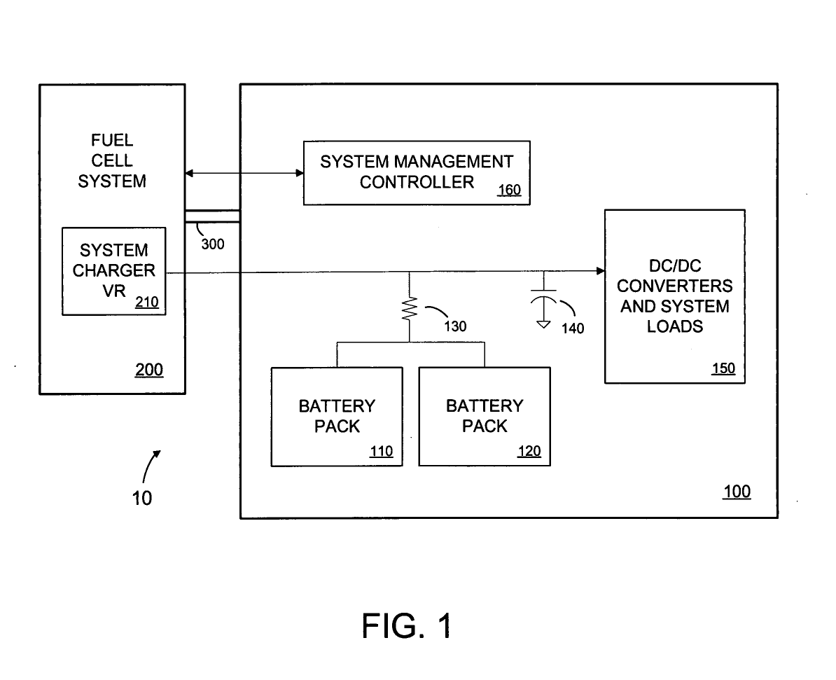

FIG. 1 is a block diagram of system 10 according to some embodiments. System 10 comprises mobile computing system 100, fuel cell system 200, and interface 300. Mobile computing system 100 may comprise a notebook computer, a telephone, a personal digital assistant, a digital camera, a tablet PC, any system including electrical hardware and requiring a power source, and a system including any combination of the foregoing. Some embodiments will described below in the context of a notebook computer.

Mobile computing system 100 is configured to consume power provided by battery pack 110 and battery pack 120. Battery pack 110 and battery pack 120 may be charged using current sense resistor 130, and the battery power is delivered using decoupling capacitor 140. Some embodiments include only one or more than two battery packs. As shown, the battery power is provided to and consumed by DC/DC converters and system loads 150, which may include the primary functional elements (e.g., processor, hard drives, memory circuits) of mobile computing system 100. Other arrangements may be employed in some embodiments.

Mobile computing system 100 may also receive power from system charger voltage regulator (VR) 210 of fuel cell system 200. System charger VR 210 may convert fuel cell-generated power from a first voltage (and/or current) level to a second voltage (and/or current) level. According to some examples, the power is converted and output by system charger VR 210 at 8.7 to 12.6V. The power may be received by DC/DC converters 150, which may then convert the power to different voltage levels suitable for use by various system loads 160 (e.g., 5V, 3.3V, 1V).

System charger VR 210 may also operate to selectively charge battery packs 110 and 120. Battery packs 110 and 120 may comprise one or more of any currently- or hereafter-known rechargeable battery types suitable for use with mobile computing system 100. These battery types may include, but are not limited to, Li-Ion, NiMH, Zn-Air, Li-Polymer, and Ag-ZN battery types. One or both of battery packs 110 and 120 may be mounted in a device-bay slot, a dedicated battery pack slot, and/or an external pack of mobile computing system 100. Resistor 130 may be used in this regard as a current-sensing resistor to detect and control the voltage and current levels of charging power supplied to battery packs 110 and 120.

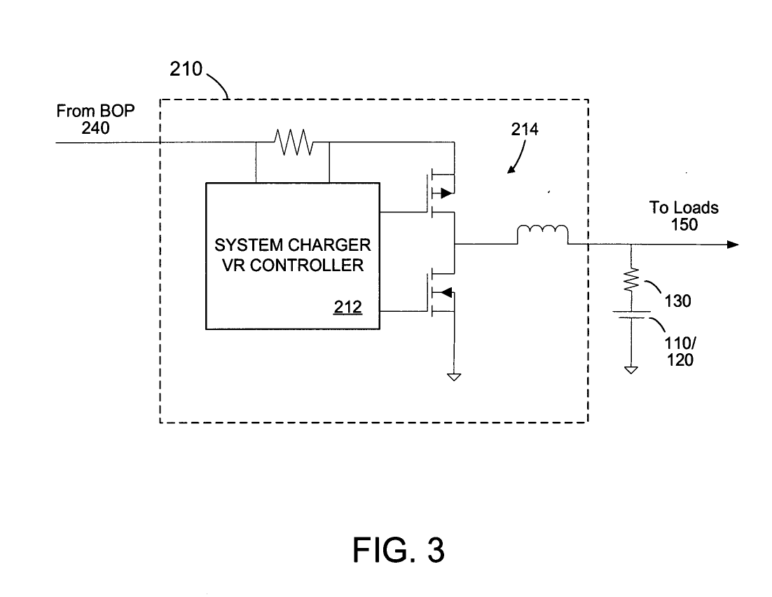

The ability of system charger VR 210 to regulate fuel cell-generated power and to charge one or both of battery packs 110 and 120 with the regulated power may be advantageous, for example, in a case that mobile computing system 100 does not include a system charger VR having similar functionality. In some embodiments, however, mobile computing system 100 includes a system charger VR to regulate received power for system loads and to charge one or both of battery packs 110 and 120 with the regulated power. Details of system charger VR 210 according to some embodiments will be described with respect to FIG. 3.

Mobile computing system 100 further comprises system management controller 160. In some embodiments, system management controller 160 provides low-level control over some aspects of system 100. Such control may comprise input device control and control over a power consumption mode of system 100. System management controller 160 may communicate with and/or control battery packs 110 and 120, and DC/DC converters and system loads 150 via a system management bus (SMBus) in accordance with System Management Bus (SMBus) Specification, ver. 2.0, Aug. 3, 2000, ©2000 SBS Implementers Forum.

System management controller 160 may receive data from fuel cell system 200. System management controller 160 may also or alternatively transmit data to fuel cell system 200 in some embodiments. As illustrated in FIG. 1, this data may be received and transmitted independently from the power received from system charger VR 210. According to some embodiments, mobile computing system 100 receives a single signal that transmits both the data and the power using currently- or hereafter-known power line data transmission techniques.

The data received from fuel cell system 200 may indicate a presence of fuel cell system 200. Such a feature may allow fuel cell system 200 to provide a smaller initial voltage to mobile computing system 100 than is otherwise required by some mobile computing systems. Specifically, a conventional mobile computing system may include a connector for receiving power from an external AC/DC adapter. The computing system holds the connector at a threshold voltage (e.g., 15VDC) that is lower than a supply voltage produced by a compatible external AC/DC adapter (e.g., 19VDC). The computing system therefore determines that an external AC/DC adapter is connected to the connector if it detects a voltage on the connector that is greater than the threshold voltage.

According to some embodiments, system management controller 160 transmits data to fuel cell system 200. The data may indicate an amount of power that mobile computing system 100 desires from fuel cell system 200. The data may be transmitted after controller 160 receives data from fuel cell system 200 indicating the presence of fuel cell system 200.

Interface 300 may comprise any suitable physical coupling by which mobile computing system 100 may receive fuel cell system 200. Interface 300 may comprise two or more components, with one or more components being located on each of system 100 and system 200. In some embodiments, interface 300 is configured to removably couple mobile computing system 100 and fuel cell system 200 so that fuel cell system 200 may be swapped with another fuel cell system. Interface 300 may also include electrical connections for carrying one or more of the above-described signals and/or other signals between mobile computing system 100 and fuel cell system 200.

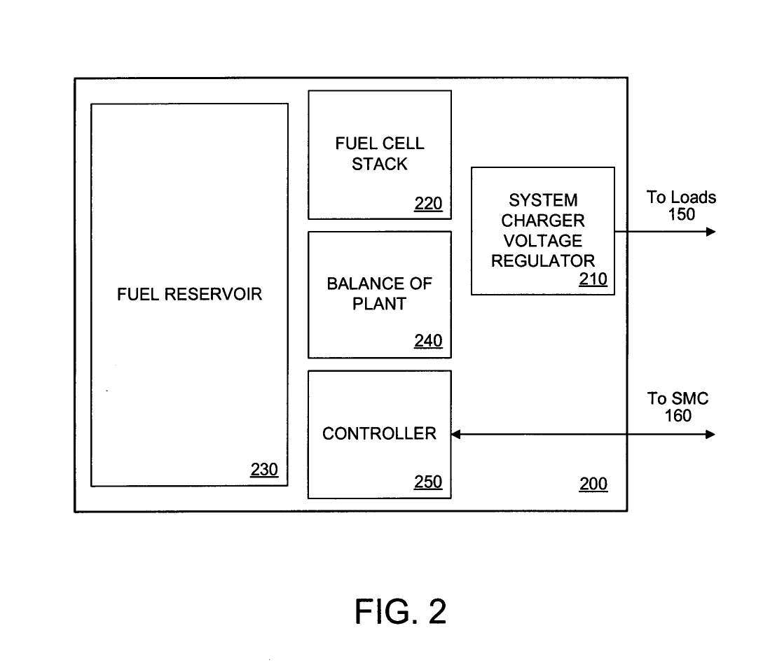

FIG. 2 is a block diagram of fuel cell system 200 according to some embodiments. Fuel cell system 200 may transmit data and generated power to mobile computing system 100. Some elements of fuel cell system 200 may comprise any currently- or hereafter-known system for converting chemical energy of a replenishable fuel source to electrical energy and for providing the electrical energy to a load.

Fuel cell system 200 according to the illustrated embodiment comprises system charger VR 210, fuel cell stack 220, fuel reservoir 230, “balance of plant” 240, and controller 250. Each of elements 210 through 250 may be in communication with one or more of elements 210 through 250.

Fuel cell stack 220 may comprise one or more fuel cells. According to some embodiments, fuel cell stack 220 comprises fifteen fuel cells connected in series to generate a voltage roughly equal to fifteen times the voltage generated by a single fuel cell. In some embodiments, each fuel cell generates electrical energy by stripping electrons from hydrogen, transmitting the electrons to an electrical circuit through an anode, transmitting the stripped hydrogen ions (H⁺) to a cathode through a proton exchange membrane, receiving the electrons at the cathode, and recombining the received electrons with the stripped hydrogen ions (H⁺) and with oxygen to produce water as exhaust. Many alternative implementations of the above process currently exist and will be created in the future. Elements of fuel cell stack 220 may vary across the alternative implementations, including but not limited to anode material, cathode material, catalyst used for the stripping and recombining procedures, and proton exchange membrane structure and composition.

Fuel reservoir 230 may comprise any currently- or hereafter-known fuel cell fuel reservoir. Fuel reservoir 230 stores fuel from which the hydrogen used to power fuel cell stack 220 is derived. Fuel reservoir 230 may be removable and replaced with a similar fuel reservoir once the fuel of fuel reservoir 230 is exhausted. In some embodiments, fuel reservoir 230 is refillable so the physical structure of fuel reservoir 230 need not be removed in order to replenish fuel cell system 200.

Fuel reservoir 230 may store pure hydrogen, methanol, reformed methanol, ethanol, and/or any other currently- or hereafter-known fuel suitable for fuel cells. Fuel reservoir 230 may include elements for extracting hydrogen from the stored fuel and/or for monitoring an amount of fuel stored in fuel reservoir 230.

Balance of plant 240 may comprise elements used to facilitate the fuel cell process. Depending on the particular implementation of fuel cell system 200, such elements may comprise one or more of sensors, pumps, compressors, control valves, heat exchangers, hoses, blowers, control systems, a power conditioner, a fuel reformer, an inverter, and other elements.

Controller 250 provides electronic monitoring and control over one or more other elements of fuel cell system 200. Controller 250 may comprise one or more integrated circuits, which may be preprogrammed and/or capable of executing program code received from an external source and/or an internal memory. Controller 250 may transmit data to and receive data from system management controller 160 according to some embodiments. The transmitted data may indicate a presence of fuel cell system 200 and the received data may indicate an amount of power that mobile computing system 100 desires from fuel cell system 200.

As described above, system charger VR 210 may receive power from balance of plant 240 at a first voltage (and/or current) level and generate regulated power having a second voltage (and/or current) level. The power may be transmitted to DC/DC converters 150 and/or to battery packs 110 and 120 for charging thereof. System charger VR 210 may regulate the power based on varying loads and/or instructions received by controller 250 from system management controller 160. According to some embodiments, system charger VR 210 receives electrical energy from balance of plant 240 and outputs regulated power based on signals received from controller 250.

FIG. 3 is a block diagram of system charger VR 210 according to some embodiments. The arrangement of FIG. 3 may be characterized as a Buck converter, although other characterizations and configurations may be employed in some embodiments.

System charger VR controller 212 may receive control signals from controller 250. Based on the control signals, system charger VR controller 212 controls MOSFETs 214 to regulate power that is received from balance of plant 240. As illustrated, the regulated power may be transmitted to loads 150 and to battery packs 110 and 120 through resistor 130. According to some embodiments, controller 250 transmits the control signals to system charger VR controller 212 based on data received from system management controller 160 that indicates a desired amount of power.

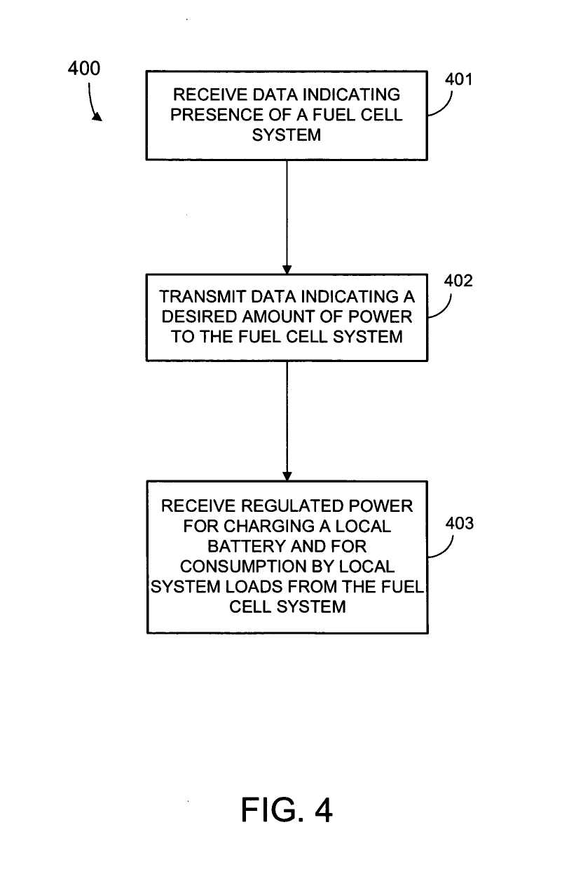

FIG. 4 is a flow diagram of process 400. Process 400 illustrates procedures executed by mobile computing system 100 to utilize power from fuel cell system 200 according to some embodiments. Process 400 may be executed by any combination of discrete components, integrated circuits, and/or software.

Data indicating the presence of a fuel cell system is initially received at 401. According to some examples, system management controller 160 receives the data from controller 250 of fuel cell system 200. The data may comprise any data capable of indicating a presence of fuel cell system 200 to system management controller 160.

Next, at 402, data indicating a desired amount of power is then transmitted to the fuel cell system. System management controller 160 may transmit this data to controller 250 of fuel cell system 200. Controller 250 may, in response, transmit control signals to system charger VR controller 212 in order to regulate power received from other elements of fuel cell system 200 and to output the regulated power to mobile computing system 100.

The regulated power is received from the fuel cell system at 403. The regulated power may be used for charging a local battery and for consumption by local system loads. In the present example, mobile computing system 100 receives the regulated power and the power is directed to DC/DC converters and system loads 150 as well as to battery packs 110 and 120. Process 400 may therefore be useful at least in a case where mobile computing system 100 does not include elements to regulate received power for system loads and to charge a battery pack with the regulated power.

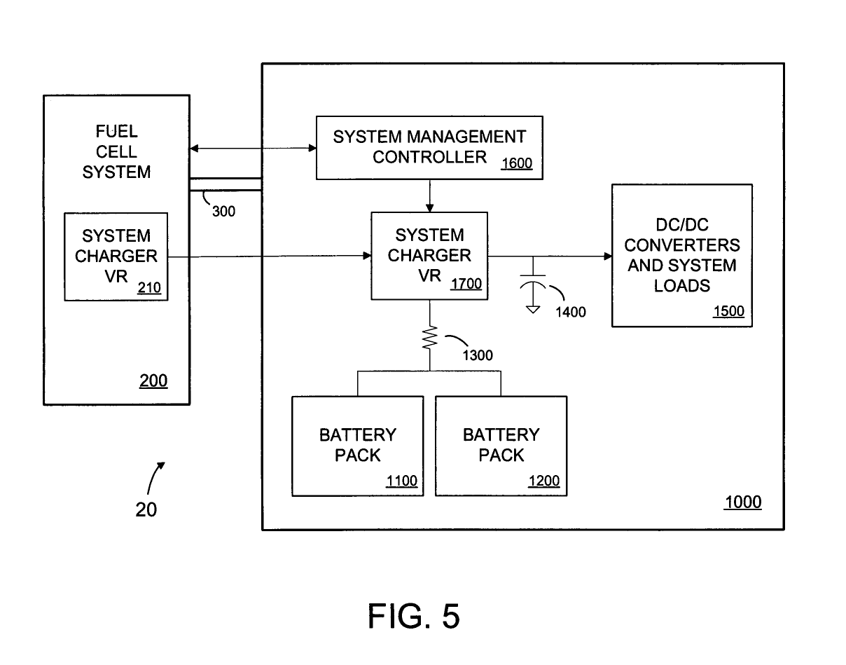

FIG. 5 is a block diagram of system 20 according to some embodiments. System 20 comprises fuel cell system 200 and interface 300 as described above and mobile computing device 1000. System 20 may be used to execute process 400. Except as noted below, the components of mobile computing device 1000 may be implemented and may function similarly to the identically-named components of mobile computing device 100 of FIG. 1.

Mobile computing device 1000 includes system charger VR 1700. System charger VR 1700 may receive regulated power from system charger VR 210 of fuel cell system 200, regulated the received power, transmit the regulated power to DC/DC converters and system loads 1500, and charge battery packs 1100 and 1200 with the regulated power. System charger VR 1700 may include a circuit controllable to deactivate system charger VR 1700 and to pass the regulated power received from fuel cell system 200 to system loads 1500 and/or to battery packs 1100 and 1200.

System management controller 1600 may communicate with and/or control system charger VR 1700, battery packs 1100 and 1200, and DC/DC converters and system loads 1500 via an SMBus. System management controller 1600 may control system charger VR 1700 to pass the regulated power received from fuel cell system 200 to system loads 1500 and/or to battery packs 1100 and 1200.

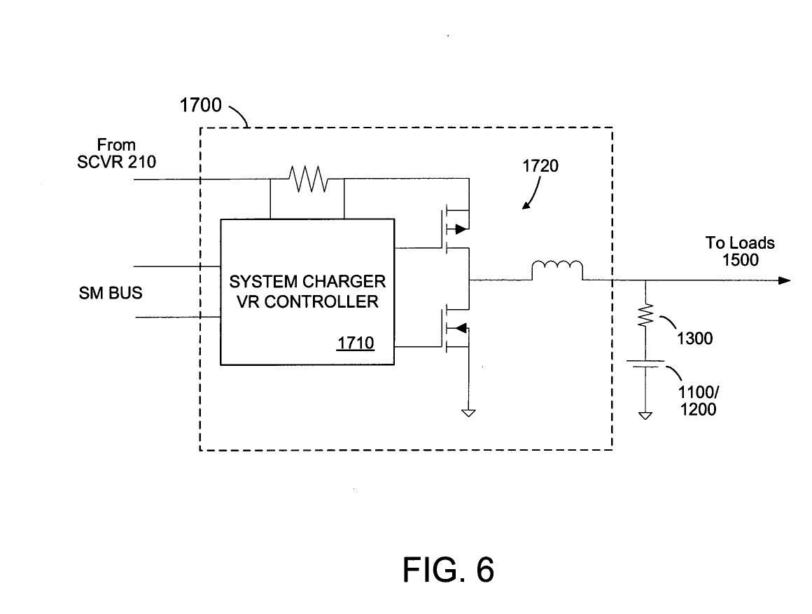

FIG. 6 is a block diagram of system charger VR 1700 according to some embodiments. System charger VR 1700 of FIG. 6 includes system charger VR controller 1710 and MOSFETs 1720. As shown, system charger VR controller 1710 may deliver control signals to MOSFETs 1720 to regulate power received from system charger VR 210 of fuel cell system 200. The regulated power may then be delivered to system loads 1500 and/or to battery packs 1100 and 1200.

System charger VR controller 1710 may receive an instruction from system management controller 1600 via an SMBus. According to some embodiments, the instruction may instruct controller 1710 to “deactivate” system charger VR 1700 in order to pass regulated power received from system charger VR 210 to system loads 1500 and/or to battery packs 1100 and 1200. In response, system charger VR controller 1710 may transmit signals to turn on its p-channel MOSFET and turn off its n-channel MOSFET. Any regulated power received from system charger VR 210 is thereby passed to system loads 1500 and to battery packs 1100 and 1200.

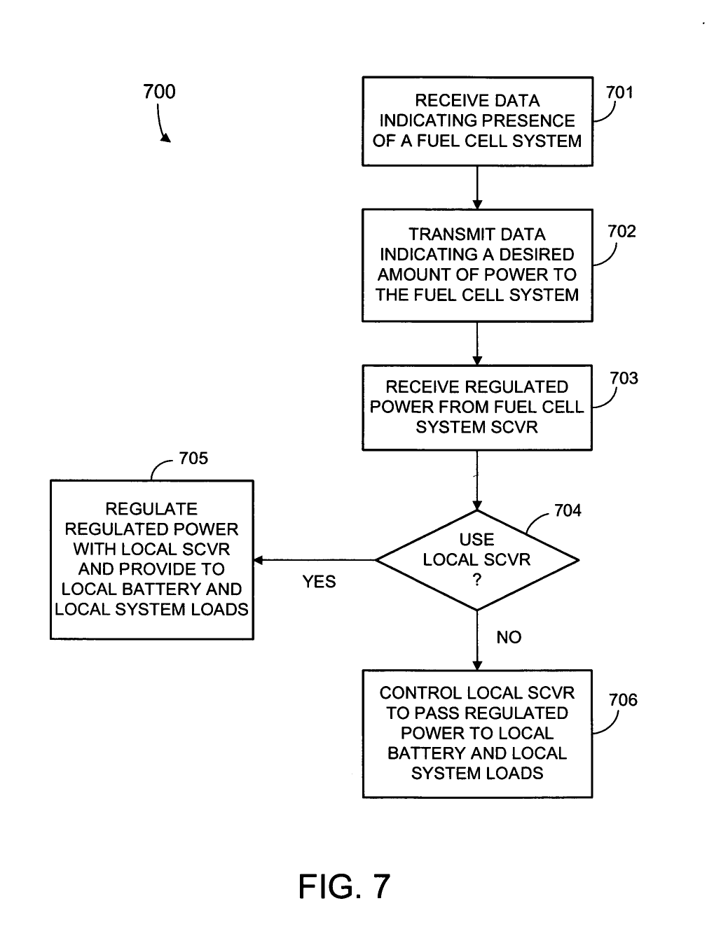

FIG. 7 is a flow diagram of process 700. Process 700 illustrates procedures executed by mobile computing system 1000 to utilize power from fuel cell system 200 according to some embodiments. Process 700 may be executed by any combination of discrete components, integrated circuits, and/or software.

Initially, at 701, data indicating the presence of a fuel cell system is received. System management controller 1600 may receive the data from controller 250 of fuel cell system 200. The data may comprise any data capable of indicating a presence of fuel cell system 200 to system management controller 1600.

At 702, data indicating a desired amount of power is then transmitted to the fuel cell system. System management controller 1600 may transmit this data to controller 250 of fuel cell system 200. In response, controller 250 may transmit control signals to system charger VR controller 212 in order to regulate power received from other elements of fuel cell system 200 and to output the regulated power to mobile computing system 1000.

The regulated power is received from the fuel cell system charger voltage regulator at 703. Next, at 704, it is determined whether to use system charger VR 1700 to regulate the received power. The determination at 704 may be performed by system management controller 1600, and may be based on any factors, including but not limited to information regarding the operation of system 1000. If the determination is positive, the received power is regulated at 705 by system charger VR 1700 and the thusly-regulated power is provided to DC/DC converters and local system loads 1500 and to battery packs 1100 and 1200.

If the determination at 704 is negative, the local system charger is controlled at 706 to pass the power received from the fuel cell system charger VR to a local battery and to local system loads. According to some embodiments of 706, system charger VR 1700 is deactivated as described with respect to FIG. 6 so as to pass regulated power received from system charger VR 210 to DC/DC converters and system loads 1500 and/or to battery packs 1100 and 1200.

The several embodiments described herein are solely for the purpose of illustration. Some embodiments may include any currently or hereafter-known versions of the elements described herein. Therefore, persons skilled in the art will recognize from this description that other embodiments may be practiced with various modifications and alterations.

What is claimed is:

1. An apparatus for use with a mobile computing system, comprising:
a fuel cell to generate power; and
a voltage regulator coupled to the fuel cell, the voltage regulator to regulate the generated power, and to charge a battery of the mobile computing system with the regulated power.

2. An apparatus according to claim 1,
wherein the mobile computing system does not comprise a second voltage regulator to regulate the regulated power and to charge the battery.

3. An apparatus according to claim 1,
wherein the mobile computing system comprises a second voltage regulator to regulate the regulated power and to charge the battery.

4. An apparatus according to claim 3, the second voltage regulator comprising:
a circuit controllable to deactivate the second voltage regulator and to pass the regulated power from the voltage regulator to the battery.

5. An apparatus according to claim 3, the second voltage regulator comprising:
a circuit controllable to deactivate the second voltage regulator and to pass the regulated power from the voltage regulator to system loads of the mobile computing system.

6. An apparatus according to claim 5, wherein the circuit is further controllable to pass a portion of the regulated power from the voltage regulator to the battery.

7. An apparatus according to claim 1, further comprising an interface to removably couple the apparatus to the mobile computing system.

8. An apparatus comprising:
a mobile computing system; and
a battery to provide battery power to the mobile computing system,
wherein the mobile computing system does not comprise a voltage regulator to provide regulated power to the mobile computing system and to charge the battery.

9. An apparatus according to claim 8,
the mobile computing system comprising an interface to receive a fuel cell system to generate power, to regulate the generated power, to provide a portion of the regulated power to system loads of the mobile computing system, and to provide a second portion of the regulated power to charge the battery.

10. An apparatus comprising:
a mobile computing system having system loads;
a battery; and
a voltage regulator to regulate received power and to provide the regulated power to the system loads and to the battery,
wherein the voltage regulator is controllable to pass, without regulation, power received from a fuel cell system to the system loads and to the battery.

11. An apparatus according to claim 10,
the mobile computing system comprising an interface to receive a fuel cell system to generate fuel cell power, to regulate the generated fuel cell power, and to provide the regulated fuel cell power to the voltage regulator.

12. An apparatus according to claim 10, further comprising:
a system management controller to control the voltage regulator to pass, without regulation, the power received from the fuel cell system to the system loads and to the battery.

13. A system comprising:
a mobile computing system comprising:
system loads; and
a battery to provide battery power to the system loads; and
a fuel cell system comprising:
a fuel cell to generate power; and
a voltage regulator coupled to the fuel cell, the voltage regulator to regulate the generated power, and to charge the battery with the regulated power.

14. A system according to claim 13,
wherein the mobile computing system does not comprise a second voltage regulator to receive and to regulate the regulated power.

15. A system according to claim 13,
wherein the mobile computing system comprises a second voltage regulator to regulate the regulated power and to charge the battery.

16. A system according to claim 15, the second voltage regulator comprising:
a circuit controllable to deactivate the second voltage regulator and to pass the regulated power from the voltage regulator to the system loads.

17. A system according to claim 16, wherein the circuit is further controllable to pass a portion of the regulated power from the voltage regulator to the battery.

18. A method for a mobile computing system, comprising:
transmitting data indicating an amount of desired power to a fuel cell system; and
receiving, from the fuel cell system, regulated power for charging a battery and for consumption by system loads.

19. A method according to claim 18, further comprising:
receiving presence data from the fuel cell system, the presence data indicating the presence of the fuel cell system.

20. A method for a mobile computing system, comprising:
receiving regulated power from a fuel cell system voltage regulator;
determining whether to regulate the regulated power with a system charger voltage regulator of the mobile computing system; and
if it is determined not to regulate the regulated power with the system charger voltage regulator, controlling the system charger voltage regulator to pass the regulated power to a battery of the mobile computing system and to system loads of the mobile computing system.

21. A method according to claim 20, further comprising:
if it is determined to regulate the regulated power with the system charger voltage regulator, regulating the regulated power with the system charger voltage regulator and transmitting the regulated regulated power to the battery of the mobile computing system and to the system loads of the mobile computing system.

22. A method according to claim 20, further comprising:
receiving presence data from the fuel cell system, the presence data indicating the presence of the fuel cell system; and
transmitting data indicating an amount of desired power to the fuel cell system.

23. A system comprising:
a mobile computing system comprising:
system loads; and
a Li-Ion battery to provide battery power to the system loads; and
a fuel cell system comprising:
a fuel cell to generate power; and
a voltage regulator coupled to the fuel cell, the voltage regulator to regulate the generated power, and to charge the battery with the regulated power.

24. A system according to claim 23,
wherein the mobile computing system does not comprise a second voltage regulator to receive and to regulate the regulated power.

25. A system according to claim 23,
wherein the mobile computing system comprises a second voltage regulator to regulate the regulated power and to charge the battery.
